(19) United States
(12) Patent Application Publication
(10) Pub. No.: US 2025/0273177 A1
(43) Pub. Date: Aug. 28, 2025

(54) Modulated Brightness Adjustment for Reflective Displays

(71) Applicant: Apple Inc., Cupertino, CA (US)

(72) Inventors: Jose A Dominguez-Caballero, San Jose, CA (US); Ganghun Kim, Milpitas, CA (US); Ching-Hua Wang, Mountain View, CA (US); Ting Chia Chang, San Jose, CA (US); Sheng Zhang, Saratoga, CA (US); Fausto Annicchiarico Petruzzelli, San Francisco, CA (US); Lingtao Wang, Cupertino, CA (US)

(21) Appl. No.: 19/061,281

(22) Filed: Feb. 24, 2025

Related U.S. Application Data
(60) Provisional application No. 63/558,452, filed on Feb. 27, 2024.

(51) Int. Cl. G09G 3/34; G02B 27/01

(52) U.S. Cl. CPC G09G 3/346; G02B 27/0172; G09G 2320/064

(57) ABSTRACT

An electronic device having a display is provided. The device may include a projector that provides image light to a waveguide for display at an eye box. The projector may include light sources that provide illumination light to a reflective display panel. The panel may generate the image light by modulating image data onto the illumination light. To mitigate postcard artifacts at the eye box during low light conditions, the projector may perform hierarchical dimming that includes analog dimming, modulation-based dimming, and digital dimming as luminance decreases. The modulation-based dimming may include reducing a bit depth of a display modulation sequence in the image data and compressing the display modulation sequence over time. A display modulation sequence may be time-stretched to match the brightness of a preceding display modulation sequence to prevent flicker.

This application claims the benefit of U.S. Provisional Patent Application No. 63/558,452, filed Feb. 27, 2024, which is hereby incorporated by reference herein in its entirety.

### FIELD

This relates generally to electronic devices, including electronic devices with displays.

### BACKGROUND

Electronic devices often include displays that display images. The displays include optics that redirect the images for view by a user. It can be challenging to design electronic devices with displays that display high quality images across a variety of usage contexts.

For example, consider a scenario in which a user is operating an electronic device in a dark environment. If care is not taken, light leakage and other non-idealities in the optics can minimize contrast of the images and/or can produce visible artifacts that can be distracting to the user. It is within this context that the embodiments herein arise.

### SUMMARY

An aspect of the disclosure provides an electronic device. The electronic device can include one or more light sources configured to generate illumination light based on a drive current. The electronic device can include a reflective display panel configured to receive image data and configured to generate image light by reflecting the illumination light based on the image data. The electronic device can include a waveguide configured to direct the image light towards an eye box. The electronic device can include one or more processors configured to adjust the image light between a first brightness and a second brightness using the drive current, the second brightness being lower than the first brightness. The one or more processors can be configured to adjust the image light between the second brightness and a third brightness by adjusting bit planes of a display modulation sequence in the image data, the third brightness being lower than the second brightness.

An aspect of the disclosure provides an electronic device. The electronic device can include one or more light sources configured to generate illumination light. The electronic device can include a reflective display panel configured to receive image data and configured to generate image light by reflecting the illumination light based on the image data, wherein the image data implements a display modulation sequence. The electronic device can include a waveguide configured to direct the image light towards an eye box. The electronic device can include one or more processors configured to dim the image light by at least reducing a bit depth of the display modulation sequence.

An aspect of the disclosure provides a method of operating an electronic device. The method can include generating, using one or more light sources, illumination light. The method can include generating, using a reflective display panel, image light based on the illumination light. The method can include directing, using a waveguide, the image light towards an eye box. The method can include dimming, using one or more processors, the image light. Dimming the image light can include driving, at a first time, the reflective display panel using a first sequence of bit planes for a first duration, and driving, at a second time after the first time, the reflective display panel using the first sequence of bit planes for a second duration less than the first duration.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide that receives light from a projector having a reflective display panel in accordance with some embodiments.

FIG. 3 is a top view of an illustrative projector having a reflective display panel in accordance with some embodiments.

FIG. 4 is a timing diagram of an illustrative display modulation sequence that may be used by a projector having a reflective display panel to produce light that is provided to a waveguide in accordance with some embodiments.

FIG. 5 is a flow chart of illustrative operations involved in adjusting the brightness of a projector having a reflective display panel in accordance with some embodiments.

FIG. 6 is a flow chart of illustrative operations involved in performing hierarchical brightness adjustments using a projector having a reflective display panel in accordance with some embodiments.

FIG. 7 is a diagram showing how an illustrative reflective display panel may perform modulation-based dimming in accordance with some embodiments.

FIG. 8 is a flow chart of illustrative operations involved in performing modulation-based dimming using a reflective display panel in accordance with some embodiments.

### DETAILED DESCRIPTION

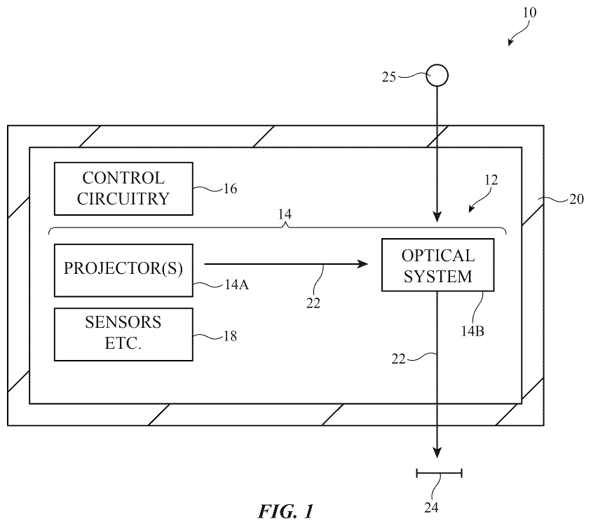

An illustrative system 10 having a device with one or more near-eye display systems is shown in FIG. 1. System 10 may be an electronic device such as a head-mounted device (HMD) having one or more near-eye displays such as displays 14 mounted within support structure (housing) 20. System 10 may be, for example, a virtual reality, mixed reality, and/or augmented reality headset, helmet, goggles, or glasses. Displays 14 may include one or more display projectors such as projectors 14A and one or more optical systems such as optical systems 14B. Projectors 14A may be mounted in a support structure such as support structure 20. Each projector 14A may output light 22 (sometimes referred to herein as image light 22) that is redirected towards a user's eyes at eye box 24 using an associated one of optical systems 14B.

Support structure 20 may have the shape of a pair of eyeglasses (e.g., supporting frames), may form a housing having a helmet shape, or may have other configurations to help in mounting and securing the components of displays 14 on the head or near the eye of a user. Support structure 20 may, for example, may include portions (e.g., head-mounted support structures) formed from fabric, polymer, metal, and/or other material. Support structure 20 may include a strap or other head-mounted support structures to help support system 10 on a user's head. Support structure 20 may include a main housing portion that supports electronic components and/or optical components such as optical systems 14B. Support structure 20 may include temple portions that extend from opposing sides of the main housing portion (e.g., for placement over or on the cars of the user). The temple portions may be rotatable relative to the main housing portion or may be at a fixed orientation relative to the main housing portion. Projectors 14A may be disposed in the temple portions if desired.

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Control circuitry 16 may include processing circuitry such as one or more processors (e.g., microprocessors, microcontrollers, digital signal processors, baseband processors, power management units, audio chips, graphics processing units, application specific integrated circuits, central processing units, etc.). Software code (instructions) may be stored on storage in control circuitry 16 and executed by processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide system 10 with user input. Input-output devices 12 may also be used to gather information on the environment in which system 10 (e.g., a head-mounted device) is operating. Output components in devices 12 may allow system 10 to provide a user with output and may be used to communicate with external electrical equipment. Input-output devices 12 may include sensors and other components 18. If desired, components 18 may include gaze tracking sensors that gather gaze image data from a user's eye at eye box 24 to track the direction of the user's gaze in real time.

Components 18 may include one or more sensors. Sensors in components 18 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, the sensors in components 18 may include optical sensors such as optical sensors that emit and detect light, ultrasonic sensors, optical touch sensors, optical proximity sensors, and/or other touch sensors and/or proximity sensors, monochromatic and color ambient light sensors, image sensors (e.g., cameras), fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion of system 10 and/or information about a pose of a user's head (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, three-dimensional camera systems such as depth sensors (e.g., structured light sensors and/or depth sensors based on stereo imaging devices that capture three-dimensional images) and/or optical sensors such as self-mixing sensors and light detection and ranging (lidar) sensors that gather time-of-flight measurements (e.g., time-of-flight cameras), humidity sensors, moisture sensors, gaze tracking sensors, electromyography sensors to sense muscle activation, facial sensors, and/or other sensors. In some arrangements, system 10 may use sensors in components 18 and/or other input-output devices to gather user input. For example, buttons may be used to gather button press input, touch sensors overlapping displays can be used for gathering user touch screen input, touch pads may be used in gathering touch input, microphones may be used for gathering audio input (e.g., voice commands), accelerometers may be used in monitoring when a finger contacts an input surface and may therefore be used to gather finger press input, etc.

Projectors 14A (sometimes referred to herein as display engines 14A, light engines 14A, or display modules 14A) may include reflective displays (e.g., displays with a light source that produces illumination light that reflects off of a reflective display panel to produce image light, such as liquid crystal on silicon (LCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in projectors 14A may include uLEDs, OLEDs, LEDS, lasers, combinations of these, or any other desired light-emitting components. Implementations in which projectors 14A include reflective displays are described herein as an example.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple near-eye displays (e.g., left and right eye displays), the focal length and positions of the lenses formed by components in optical system 14B may be selected so that any gap present between the displays will not be visible to a user (e.g., so that the images of the left and right displays overlap or merge seamlessly).

If desired, optical system 14B may contain components (e.g., an optical combiner, etc.) that allow real-world image light from real-world images or objects 25 to be combined optically with virtual (computer-generated) images such as virtual images in image light 22. In this type of system, which is sometimes referred to as an augmented reality system, a user of system 10 may view both real-world objects and computer-generated content (e.g., virtual objects) that is overlaid on top of the real-world objects. Camera-based augmented reality systems may also be used in system 10 (e.g., in an arrangement in which a camera captures real-world images of object 25 and this content is digitally merged with virtual content at optical system 14B).

System 10 may, if desired, include wireless circuitry and/or other circuitry to support communications with a computer or other external equipment (e.g., a computer that supplies display 14 with image content). The wireless circuitry may include antennas, radio-frequency transceiver circuitry, and other wireless communications circuitry and/or wired communications circuitry. The wireless circuitry may support bidirectional wireless communications between system 10 and external equipment (e.g., a companion device such as a computer, cellular telephone, or other electronic device, an accessory such as a point device or a controller, computer stylus, or other input device, speakers or other output devices, etc.) over one or more wireless links. During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

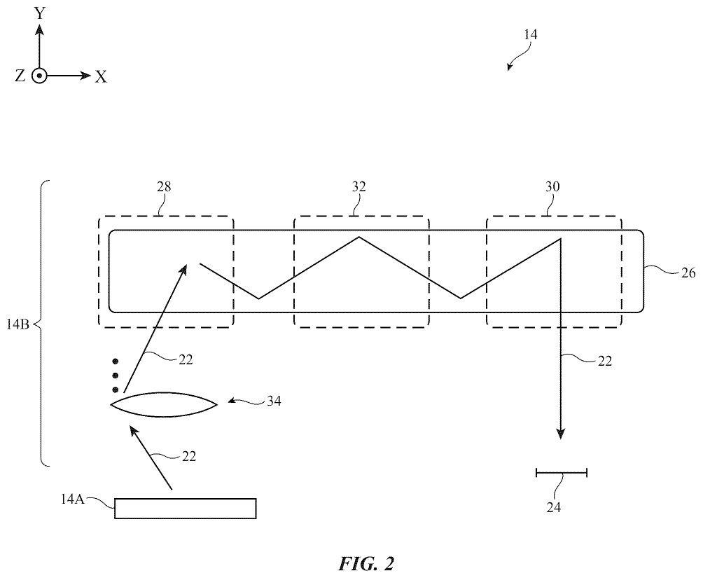

FIG. 2 is a top view of an illustrative display 14 that may be used in system 10 of FIG. 1. As shown in FIG. 2, display 14 may include one or more display projectors such as projector 14A and an optical system such as optical system 14B. Optical system 14B may include optical elements such as one or more waveguides 26. Waveguide 26 may include one or more stacked substrates (e.g., stacked planar and/or curved layers sometimes referred to herein as waveguide substrates) of optically transparent material such as plastic, polymer, glass, etc.

If desired, waveguide 26 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 26 may include holographic phase gratings such as volume holograms or thin-film holograms, meta-gratings, or any other desired diffractive grating structures. The diffractive gratings on waveguide 26 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles).

Optical system 14B may include collimating optics such as collimating lens 34. Collimating lens 34 may include one or more lens elements that help direct image light 22 towards waveguide 26. Collimating lens 34 may be omitted if desired.

As shown in FIG. 2, projector 14A may generate image light 22 associated with image content to be displayed to eye box 24. Image light 22 may be, for example, light that contains and/or represents something viewable such as a scene or object (e.g., as modulated onto the image light using the image data provided by control circuitry 16 of FIG. 1 to the projector). Image light 22 may, for example, include a stream of image frames (e.g., video data) that contain computer-generated (virtual) objects represented by pixel values in the image frames. Image light 22 may be collimated using a lens such as collimating lens 34. Optical system 14B may be used to present image light 22 output from projector 14A to eye box 24.

Optical system 14B may include one or more optical couplers such as input coupler 28, cross-coupler 32, and output coupler 30. In the example of FIG. 2, input coupler 28, cross-coupler 32, and output coupler 30 are formed at or on waveguide 26. Input coupler 28, cross-coupler 32, and/or output coupler 30 may be completely embedded within the substrate layers of waveguide 26, may be partially embedded within the substrate layers of waveguide 26, may be mounted to waveguide 26 (e.g., mounted to an exterior surface of waveguide 26), etc.

The example of FIG. 2 is merely illustrative. One or more of these couplers (e.g., cross-coupler 32) may be omitted. Optical system 14B may include multiple waveguides that are laterally and/or vertically stacked with respect to each other. Each waveguide may include one, two, all, or none of couplers 28, 32, and 30. Waveguide 26 may be at least partially curved or bent if desired.

Waveguide 26 may guide image light 22 down its length via total internal reflection. Input coupler 28 may be configured to couple image light 22 from projector 14A into waveguide 26, whereas output coupler 30 may be configured to couple image light 22 from within waveguide 26 to the exterior of waveguide 26 and towards eye box 24. Input coupler 28 may include an input coupling prism, a surface relief grating, louvered mirrors, an angled edge or face of waveguide 26, volume holograms, metagratings, a reflective layer, and/or other input coupling structures. As an example, projector 14A may emit image light 22 in the +Y direction towards optical system 14B. When image light 22 strikes input coupler 28, input coupler 28 may redirect image light 22 so that the light propagates within waveguide 26 via total internal reflection towards output coupler 30 (e.g., in the +X direction). When image light 22 strikes output coupler 30, output coupler 30 may redirect image light 22 out of waveguide 26 towards eye box 24 (e.g., back in the-Y direction). In scenarios where cross-coupler 32 is included at waveguide 26, cross-coupler 32 may redirect image light 22 in one or more directions as it propagates down the length of waveguide 26, for example. Cross-coupler 32 and/or output coupler 30 may perform one or two dimensional pupil expansion upon redirecting image light 22 if desired.

Input coupler 28, cross-coupler 32, and/or output coupler 30 may be based on reflective and refractive optics or may be based on holographic (e.g., diffractive) optics. In arrangements where couplers 28, 30, and 32 are formed from reflective and refractive optics, couplers 28, 30, and 32 may include one or more reflectors (e.g., an array of micromirrors, partial mirrors, louvered mirrors, or other reflectors). In arrangements where couplers 28, 30, and 32 are based on holographic optics, couplers 28, 30, and 32 may include diffractive gratings (e.g., volume holograms, surface relief gratings, etc.).

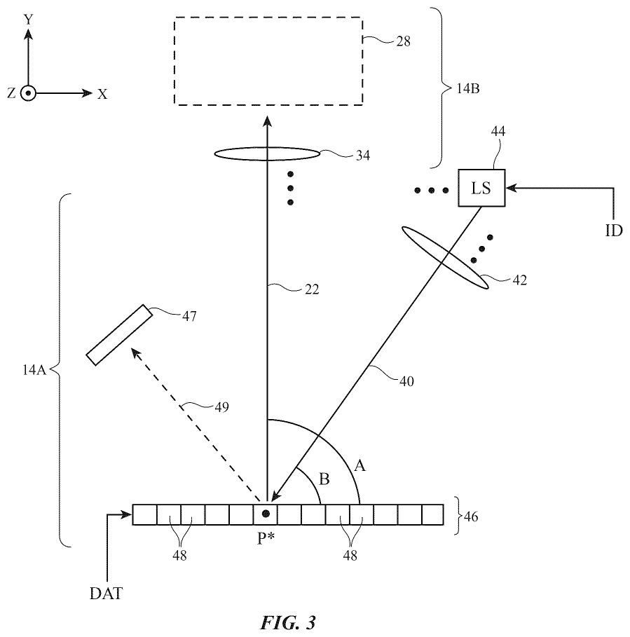

In implementations that are described herein as an example, projector 14A may include a reflective display panel that generates image light 22 and that provides the image light to waveguide 26. FIG. 3 is a top view showing how projector 14A may include a reflective display panel that generates image light 22 for waveguide 26. As shown in FIG. 3, projector 14A may include one or more light sources (LS) 44. Light sources 44 may be LED light sources, OLED light sources, uLED light sources, laser light sources, and/or any other desired light source.

Projector 14A may also include a reflective display panel such as reflective display panel 46 (e.g., a reflective spatial light modulator (SLM)). Reflective display panel 46 may be an LCOS display panel, a DMD display panel, a ferroelectric liquid crystal on silicon (fLCOS) display panel, or another type of reflective display panel. Reflective display panel 46 may have an array of individually adjustable pixels P. Each pixel P may be formed by a respective reflective element 48 in reflective display panel 46. Reflective elements 48 are sometimes also referred to herein as reflectors 48 or programable reflectors 48. In implementations where reflective display panel 46 is a DMD display panel, reflective elements 48 are mirrors such as micromirrors (e.g., micro-electromechanical-systems (MEMS)-based micromirrors), where each mirror forms a respective pixel P of reflective display panel 46.

Light sources 44 may emit illumination light 40. Illumination light 40 may include light in one or more wavelength bands (e.g., red, green, and/or blue wavelength bands). For example, light sources 44 may include a first set of one or more light sources that emit a first wavelength range of illumination light 40 (e.g., red wavelengths), a second set of one or more light sources that emit a second wavelength range of illumination light 40 (e.g., green wavelengths), and a third set of one or more light sources that emit a third wavelength range of illumination light 40 (e.g., blue wavelengths).

Optics 42 in projector 14A may direct illumination light 40 onto reflective display panel 46. Optics 42 may include one or more lens elements, prisms, partial reflectors, polarizers, reflective polarizers, filters, X-cubes, and/or other optical components. Optics 42 may, for example, provide illumination light 40 to reflective display panel 46 at an incident angle B (relative to the X-axis) across each of the reflective elements 48 in reflective display panel 46. During operation, control circuitry 16 (FIG. 1) may control reflective display panel 46 to selectively reflect illumination light 40 at each pixel (reflective element) location to produce image light 22 (e.g., image light having an image as modulated onto the illumination light by the reflective elements 48 in reflective display panel 46).

For example, in implementations where reflective display panel 46 is a DMD panel, reflective elements 48 may be individually (e.g., independently) rotatable between two predetermined orientations (states) such as an “ON” state and an “OFF” state. Control circuitry 16 of FIG. 1 may individually adjust the state of each pixel based on the images to be displayed using display 14. The example of FIG. 3 illustrates the operation of a single pixel P* on illumination light 40 for the sake of clarity. However, in general, similar operations are performed at each pixel P (reflective clement 48) across the lateral area of reflective display panel 46. Reflective display panel 46 may include any desired number of pixels arranged into rows and columns or in any other desired pattern (e.g., tens of pixels, hundreds of pixels, thousands of pixels, tens of thousands of pixels, hundreds of thousands of pixels, etc.).

As shown in FIG. 3, when pixel P* is in the “ON” state, the mirror used to form that pixel P* may be at a first orientation (e.g., an “ON” orientation or state). In this orientation, the mirror may reflect illumination light 40 (as image light 22) at an output angle A towards lens 34. Lens 34 may direct image light 22 towards input coupler 28 of optical system 14B. When pixel P* is in the “OFF” state, pixel P* may direct illumination light 40 away from optical system 14B, as shown by arrow 49 (e.g., towards a light sink 47 such as a baffle that includes light absorbing materials and/or textured structures that effectively extinguish the reflected light to prevent the reflected light from being received at the eye box). By adjusting pixel P* between the “ON” and “OFF” states in this way, pixel P* may either direct illumination light 40 towards input coupler 28 and the eye box (as image light 22) or may direct illumination light 40 outside of the projection optics (i.e., towards light sink 47) so that the beam is not received at the eye box.

Control circuitry 16 (FIG. 1) may provide image data DAT to reflective display panel 46 (e.g., over a control bus or path). Image data DAT may specify the state for each pixel P in reflective display panel 46 over time to cause reflective display panel 46 to modulate frames of image data DAT onto illumination light 40, producing image light 22 having the frames of image data DAT modulated thereon. At any given time, reflective display panel 46 configures its reflective elements 48 according to the corresponding pixel value (e.g., ON or OFF) specified by the image data DAT received by reflective display panel 46. Control circuitry 16 may, for example, include display rendering circuitry, display pipeline circuitry, and/or display driver circuitry (e.g., as implemented on, controlled by, and/or executed using one or more processors in control circuitry 16) that generate image data DAT and that provide image data DAT to reflective display panel 46 for modulating a corresponding stream of images onto image light 22.

Control circuitry 16 may also control (drive) light sources 44 using a drive signal. The drive signal may include a current signal such as drive current ID and/or a voltage signal such as a drive voltage. Implementations in which the drive signal includes drive current ID are described herein as an example. Control circuitry 16 may adjust the magnitude of the drive signal (e.g., drive current ID) to adjust the intensity of the illumination light 40 produced by each of the light sources 44 in projector 14A (e.g., where higher signal magnitudes produce higher intensities than lower signal magnitudes). Additionally or alternatively, control circuitry 16 may control the intensity of the illumination light 40 produced by light sources 44 by supplying the drive signal (e.g., drive current ID) to light sources 44 using a corresponding pulse width modulation (PWM) scheme. Control circuitry 16 may adjust the intensity of illumination light 40 by adjusting the PWM scheme (e.g., by adjusting the duty cycle of drive current ID).

Control circuitry 16 may time-synchronize drive current ID with the image data DAT provided to reflective display panel 46. When generating image light 22, control circuitry 16 may supply image data DAT to reflective display panel 46 and may control light sources 44 using a corresponding display modulation sequence. Image data DAT may, for example, include a series of bit planes that are provided, in accordance with the display modulation sequence, to reflective display panel 46 for different durations and synchronized to different colors of the illumination light 40 emitted by light sources 44.

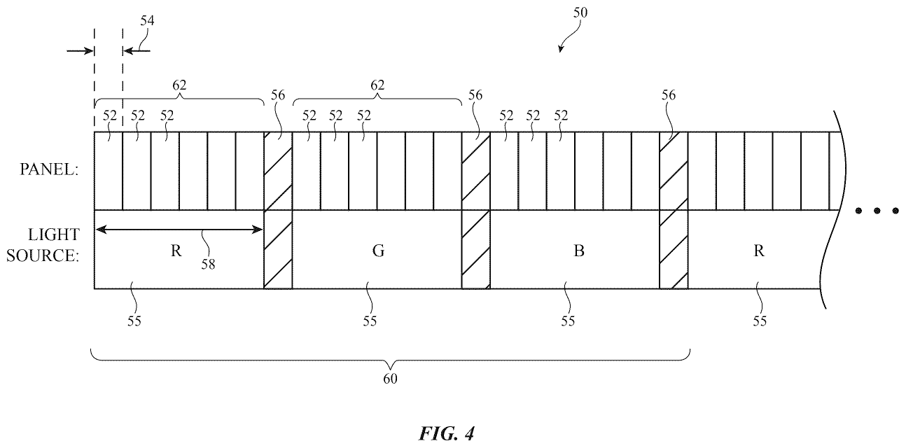

FIG. 4 is a timing diagram showing one example of a display modulation sequence 50 that may be used to drive reflective display panel 46. The bottom row of FIG. 4 describes the state of light sources 44 over time (e.g., the color of the illumination light 40 over time). Blocks 55 graphically represent the wavelength range (color) of the illumination light 40 produced by light sources 44 over time. For example, light sources 44 may generate red (R) illumination light 40 during a first (red) block 55, may generate green (G) illumination light 40 during a second (green) block 55, may generate blue (B) illumination light 40 during a third (blue) block 55, etc. A consecutive set of one red block 55, one green block 55, and one blue block 55 is sometimes also referred to herein as a color cycle 60. Display modulation sequence 50 may include any desired number of color cycles 60 (e.g., a single color cycle 60, two color cycles 60, more than two color cycles 60, etc.) and may include any desired number of blocks 55 of any desired colors in any desired sequence.

The upper row of FIG. 4 describes the state of reflective display panel 46 as driven using image data DAT. The image data DAT provided to reflective display panel 46 may include a sequence of bit planes 52 over time. Each bit plane 52 contains an array or plane of pixel values (e.g., ON or OFF values), each for a respective one of the pixels P in reflective display panel 46. Image data DAT may include image data associated with each color channel of illumination light 40. For example, bit planes 52 that overlap red blocks 55 include red pixel values and configure reflective display panel 46 to modulate the red pixel values (red image data) onto red illumination light 40 to produce corresponding red image light 22. Similarly, bit planes 52 that overlap green blocks 55 include green pixel values and configure reflective display panel 46 to modulate the green pixel values (green image data) onto green illumination light 40 to produce corresponding green image light 22. Similarly, bit planes 52 that overlap blue blocks 55 include blue pixel values and configure reflective display panel 46 to modulate the blue pixel values (blue image data) onto blue illumination light 40 to produce corresponding blue image light 22. By rapidly cycling through color cycles 60 and the corresponding bit planes 52 faster than the response of the unaided human eye, image light 22 may be perceived as full color image light containing full color images despite the time division duplexing scheme used to modulate image data onto different colors of illumination light 40.

The sequence of bit planes 52 overlapping a given block 55 are sometimes also referred to collectively herein as color field 62. Each color field 62 has an associated color, given by the color of the illumination light 40 illustrated by the overlapping block 55. Blocks 55 and the overlapping color fields 62 are separated from each other in time by dark periods 56. Dark periods 56 may accommodate hardware time required by light sources 44 to switch between different colors of illumination light 40 and/or required by reflective display panel 46 to be reconfigured using bit planes 52 of a different color.

Each bit plane 52 in display modulation sequence 50 has a corresponding bit plane width (duration) 54, corresponding to the amount of time reflective display panel 46 is configured (driven) using that bit plane 52. Different bit planes 52 may have different widths 54 or two or more bit planes 52 may have the same width 54. Suitable setting of the width 54 for each bit plane 52 may effectively weight that bit plane in the generation of image light 22. Width 54 may sometimes also be referred to herein as bit plane weight 54. The control circuitry may, for example, increase the width 54 of red bit planes 52 to increase the overall red luminance of image light 22, may increase the width 54 of blue bit planes 52 to increase the overall blue luminance of image light 22, may decrease the width 54 of green bit planes 52 to decrease the overall green luminance of image light 22, etc. The combination of widths 54 across all the bit planes 52 in display modulation sequence 50 may collectively establish the gray level of image light 22. Bit planes 52 may have a minimum width 54 dictated by the least significant bit (LSB) of the bit planes (e.g., the smallest possible pulse on the digital modulation) given the bit depth of the display modulation sequence. The bit depth is the number of bits used to define each pixel value in the image data. The bits used to define each pixel value have a corresponding LSB. For example, when the bit depth is equal to four, each pixel value is defined by a four-bit number having a most significant bit and a least significant bit. In this example, if a pixel value is “1110,” the least significant bit is “0.”

When system 10 implements an augmented reality scheme, optical system 14B transmits light from real-world objects 52 (FIG. 10) onto eye box 24 and projector 14A generates image light 22 that includes images of virtual objects. Optical system 14B combines image light 22 with the light from real-world objects 52 (sometimes also referred to herein as scene light, external light, environmental light, world light, or ambient light), which overlays the images of virtual objects in image light 22 onto the real-world objects viewed through optical system 14B at eye box 24.

Care should be taken to ensure that the images of virtual objects in image light 22 are sufficiently bright so as to be perceivable to the user given the current brightness of the world light. For example, in bright environments, the brightness of projector 14A and image light 22 may need to be increased to maximize contrast and thus visibility of the images of virtual objects in image light 22. On the other hand, in dark environments, the brightness of projector 14A and image light 22 may need to be reduced (dimmed) to avoid user discomfort (e.g., supplying the user with images of virtual objects that are too bright when the user's eyes have otherwise adapted to low levels of ambient light), to minimize content glare, and to conserve device power.

If care is not taken, the reflective display panel 46 in projector 14A can produce undesirable postcard artifacts at eye box 24 that can be distracting to the user in dark environments. Such postcard artifacts are generally perceivable as a slightly visible haze or non-zero brightness filling the entire field of view of eye box 24, even in portions of the field of view that are not otherwise provided with virtual objects in image light 22.

Postcard artifacts have a number of sources associated with the architecture of projector 14A and optical system 14B. For example, the entire area of reflective display panel 46 is generally illuminated using illumination light 40 regardless of pixel content or pixel gray level. When reflective display panel 46 is implemented using a DMD panel, stray light from gray level 0 (GL0) pixels (e.g., pixels in the OFF state) can propagate through the system to eye box 24. When reflective display panel 46 is implemented using an LCOS panel, light from GL0 pixels can also reach the eye box 24 due to leakage from polarization rejection. In addition, some illumination light 40 may produce stray light that reaches eye box 24 via diffraction off of the reflective elements 48 in reflective display panel 46 (e.g., reflective elements 48 may effectively form a diffraction grating that inadvertently diffracts some stray light towards the eye box). Non-idealities in waveguide 26 (FIG. 2) can also contribute to postcard artifacts. For example, surface roughness, spatial variation, line width roughness, and other process variations in one or more diffractive gratings on waveguide 26 can produce stray light that contributes to postcard artifacts. Edge blackening scattering and/or bulk scattering at waveguide 26 can also contribute to postcard artifacts.

To minimize the visibility of postcard artifacts at eye box 24 at peak virtual content brightness in dark environments, it may be desirable for projector 14A to reduce its brightness to less than or equal to 5 nits. In some implementations, projector 14A reduces its brightness using an analog dimming scheme. Under the analog dimming scheme, the drive current ID provided to light sources 44 (FIG. 3) is reduced to minimize the brightness of the illumination light 40 provided to reflective display panel 46. However, light sources 44 are intrinsically unstable when driven using insufficient current and/or voltage. As such, the drive signal (e.g., drive current ID) can only be reduced to a minimum magnitude before light sources 44 become unstable. Other techniques may be used to further reduce the brightness of image light 22 and projector 14A without reducing drive current ID below its minimum magnitude.

In some implementations, the brightness of projector 14A can be further reduced by reducing the duty cycle of bit planes 52 and/or by inserting one or more dark times (e.g., empty bit planes 52) into display modulation sequence 50 (e.g., reducing PWM efficiency). However, these techniques may be infeasible because bit planes 52 cannot be duty cycled below the smallest pulse on the digital modulation (e.g., binary PWM). For example, width 54 cannot be reduced to below the LSB of bit planes 52. To mitigate these issues while minimizing the appearance of postcard artifacts at eye box 24, projector 14A may adjust its brightness using a hierarchal brightness adjustment.

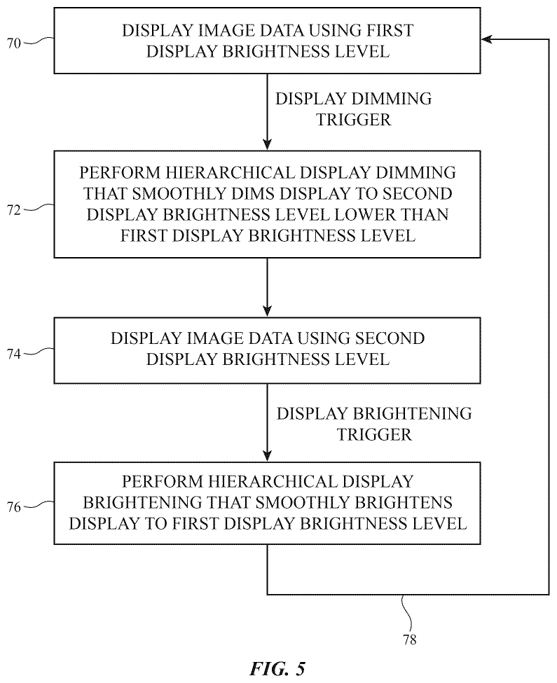

FIG. 5 is a flow chart of illustrative operations involved in adjusting the brightness of projector 14A while producing image light 22. At operation 70, projector 14A may generate and output image light 22. Projector 14A may generate image light 22 by modulating image data DAT onto illumination light 40 (FIG. 3) using one or more display modulation sequences such as display modulation sequence 50 of FIG. 4. Projector 14A outputs image light 22 at a first display brightness level (e.g., a relatively high display brightness level).

Processing may proceed to operation 72 in response to a display dimming trigger. The display dimming trigger may be triggered based on sensor data (e.g., ambient light sensor data, camera data, orientation sensor data, etc.) gathered by system 10, based on a software application running on system 10, and/or based on a user input received by system 10. The display dimming trigger may, for example, occur when the image data DAT and the ambient lighting conditions of system 10 would otherwise cause image light 22 to produce a noticeable postcard artifact at eye box 24 (e.g., when system 10 is operating in a relatively dark environment as identified by ambient light sensor and/or camera sensor data and/or when image light 22 includes relatively bright virtual objects that occupy only a small portion of the field of view of eye box 24). As another example, the display dimming trigger may occur when a user provides a user input (e.g., a gesture, button press, switch toggle, knob rotation, finger movement, etc.) and/or a software application performs an operation to instruct system 10 to reduce its display brightness. These examples are illustrative and, in general, projector 14A may perform dimming in response to any desired display dimming trigger. The display dimming trigger may also identify or be associated with a second display brightness level that is lower than the first display brightness level. The second display brightness level may be associated with or given by the current ambient lighting conditions and/or the content to be displayed in image light 22 (e.g., the second display brightness level may be a display brightness required of the projector to sufficiently mitigate postcard artifacts given current ambient light levels and the content to be displayed). A calibration operation may be used to identify the second display brightness level, for example.

At operation 72 (e.g., responsive to the display dimming trigger), projector 14A may perform hierarchical display dimming to dim or reduce the brightness of projector 14A (image light 22) to the second display brightness level. The hierarchical dimming may smoothly reduce the brightness of image light 22 to levels below what is otherwise achievable by reducing drive current ID to its minimum magnitude. The hierarchical dimming may include adjustments to drive current ID and to the display modulation sequence 50 in the image data DAT provided to reflective display panel 46. The hierarchical dimming may include timing adjustments (e.g., temporal compression and/or stretching) between display modulation sequences to modify the effective display persistence and to minimize visual artifacts associated with switching between display modulation sequences such as flicker, contouring, dithering artifacts, white point change, etc.

At operation 74, projector 14A may generate and output (dimmed) image light 22 at the second display brightness level. Processing may proceed to operation 76 in response to a display brightening trigger. The display brightening trigger may be triggered based on sensor data (e.g., ambient light sensor data, camera data, orientation sensor data, etc.) gathered by system 10, based on a software application running on system 10, and/or based on a user input received by system 10. The display brightening trigger may, for example, occur when the image data DAT and the ambient lighting conditions of system 10 would not otherwise cause image light 22 to produce noticeable postcard artifacts at eye box 24 (e.g., when system 10 is operating in a relatively bright environment as identified by ambient light sensor and/or camera sensor data and/or when image light 22 includes virtual objects that occupy substantially all of the field of view of eye box 24). As another example, the display brightening trigger may occur when a user provides a user input (e.g., a gesture, button press, switch toggle, knob rotation, finger movement, etc.) and/or a software application performs an operation to instruct system 10 to increase its display brightness. These examples are illustrative and, in general, projector 14A may perform brightening in response to any desired display brightening trigger.

At operation 76 (e.g., responsive to the display brightening trigger), projector 14A may perform hierarchical display brightening to brighten or increase the brightness of projector 14A and image light 22 (e.g., back to the first display brightness level or to another display brightness level higher than the second display brightness level). The hierarchical brightening may include reversing the hierarchical dimming performed at operation 72. The hierarchical brightening may, for example, include adjustments to drive current ID and to the display modulation sequence 50 in the image data DAT provided to reflective display panel 46. The hierarchical brightening may include timing adjustments (e.g., temporal compression and/or stretching) between display modulation sequences to modify the effective display persistence and to minimize visual artifacts associated with switching between display modulation sequences such as flicker, contouring, dithering artifacts, white point change, etc. Processing may then loop back to operation 70 via path 78.

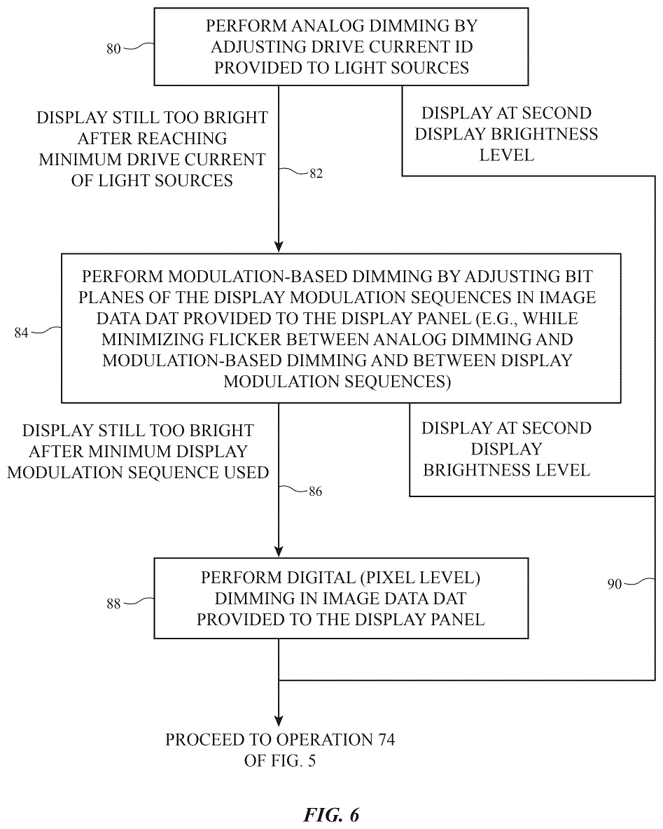

FIG. 6 is a flow chart of illustrative operations involved in performing hierarchical display dimming using projector 14A from the first display brightness level to the second display brightness level. The operations of FIG. 6 may, for example, be performed while processing operation 72 of FIG. 5. The hierarchical display dimming may involve transitioning between three different domains of display dimming as the luminance of the projector is decreased from its maximum or nominal luminance to a luminance associated with the second display brightness level.

At operation 80 (e.g., in a first domain of display dimming), control circuitry 16 (FIG. 1) and projector 14A may perform analog dimming to reduce the luminance (brightness) of image light 22 from a peak luminance to a first threshold luminance LTHA. This may include reducing the magnitude of the drive current ID provided to light sources 44 (FIG. 3) and/or adjusting the duty cycle (PWM) of drive current ID. Threshold luminance LTHA may be the luminance of image light 22 when drive current ID is provided to light sources 44 at the minimum magnitude or duty cycle associated with stable operation of light sources 44.

If/when the second brightness level corresponds to a luminance greater than threshold luminance LTHA, analog dimming is able to sufficiently dim projector 14A and processing may proceed to operation 74 of FIG. 5 via path 90. On the other hand, when the second brightness level corresponds to a luminance less than threshold luminance LTHA, analog dimming is not sufficient on its own to dim projector 14A to the second display brightness level given the minimum drive current associated with stable operation of light sources 44. In these situations, processing proceeds to operation 84 via path 82 to further dim projector 14A.

At operation 84 (e.g., in a second domain of display dimming), control circuitry 16 and projector 14A may perform modulation-based dimming at reflective display panel 46. If desired, drive current ID may be provided to light sources 44 at a constant magnitude and/or duty cycle during modulation-based dimming (e.g., the minimum constant magnitude and/or duty cycle that still allows light sources 44 to emit illumination light 40 without substantial instability). The modulation-based dimming may then allow projector 14A to further reduce the luminance of image light 22 from the first threshold luminance LTHA down to a second threshold luminance

LTHB that is lower than threshold luminance LTHA.

The modulation-based dimming may include adjustment to the display modulation sequences 50 (FIG. 4) of the image data DAT provided to reflective display panel 46. The adjustment to display modulation sequences 50 may include adjustment to one or more bit planes 52, one or more color fields 62, and/or one or more color cycles 60 of display modulation sequence 50 over time (e.g., as a series of display modulation sequences 50 are provided to the reflective display panel in image data DAT). The adjustment to display modulation sequences 50 may include reducing the bit depth of subsequent display modulation sequences 50 provided to the reflective display panel in image data DAT and/or temporal compression of subsequent display modulation sequences 50 provided to the reflective display panel in image data DAT. If desired, the adjustment to display modulation sequences 50 may include temporally stretching one or more of the display modulation sequences to match the luminance produced by the immediately preceding display modulation sequence provided to the reflective display panel in image data DAT, helping to mitigate flicker. Similar adjustment may be performed to minimize flicker between performing analog dimming and modulation-based dimming.

If/when the modulation-based dimming is able to reduce the brightness of projector 14A and image light 22 to the second display brightness level (e.g., if/when the second brightness level corresponds to a luminance greater than threshold luminance LTHB), modulation-based dimming is able to sufficiently dim projector 14A and processing may proceed to operation 74 of FIG. 5 via path 90. On the other hand, when the second brightness level corresponds to a luminance less than threshold luminance LTHB, modulation based dimming and analog dimming are not sufficient on their own to dim projector 14A to the second display brightness level (e.g., given the LSB of bit planes 52 at a minimum bit depth of the display modulation sequence). In these situations, processing proceeds to operation 88 via path 86 to further dim projector 14A.

At operation 88, (e.g., in a third domain of display dimming), control circuitry 16 and projector 14A may perform digital (pixel level) dimming at reflective display panel 46. Rather than adjusting display modulation sequences as in the modulation-based dimming of operation 84, digital dimming includes dimming or reducing the max gray level of image content (non-zero pixel values) in image data DAT (e.g., at pixels that form virtual objects in the displayed image light 22). This allows reduction in the brightness of projector 14A down to the second display brightness level but reduces the contrast of the virtual objects included in image light 22. Processing may then proceed to operation 74 of FIG. 5.

In this way, projector 14A may first perform simple and efficient analog dimming before switching to modulation-based dimming to further reduce the brightness of the projector below what is otherwise achievable given the minimum current requirements of light sources 44. Then, if modulation-based dimming is still insufficient to reach the second display brightness level, digital dimming may be performed to trade off contrast for a further reduction in brightness and thus postcard artifacts at eye box 24.

The operations of FIG. 6 may be reversed to perform hierarchical display brightening at operation 76 of FIG. 5. For example, during hierarchical display brightening, projector 14A may first perform digital (pixel level) brightening in the image data DAT provided to reflective display panel 46. Then, projector 14A may perform modulation-based brightening. This may include adjusting display modulation sequences 50 by increasing the bit depth of subsequent display modulation sequences 50 and/or temporal stretching of subsequent display modulation sequences 50 provided to the reflective display panel in image data DAT. If desired, the adjustment to display modulation sequences 50 may include temporally compressing one or more of the display modulation sequences to match the luminance produced by the immediately preceding display modulation sequence provided to the reflective display panel in image data DAT, helping to mitigate flicker. Similar adjustment may be performed to minimize flicker between performing digital brightening and modulation-based brightening and/or between performing modulation-based brightening and analog brightening. If further brightening is required, projector 14A may then perform analog brightening by increasing the magnitude and/or duty cycle of the drive current ID provided to light sources 44.

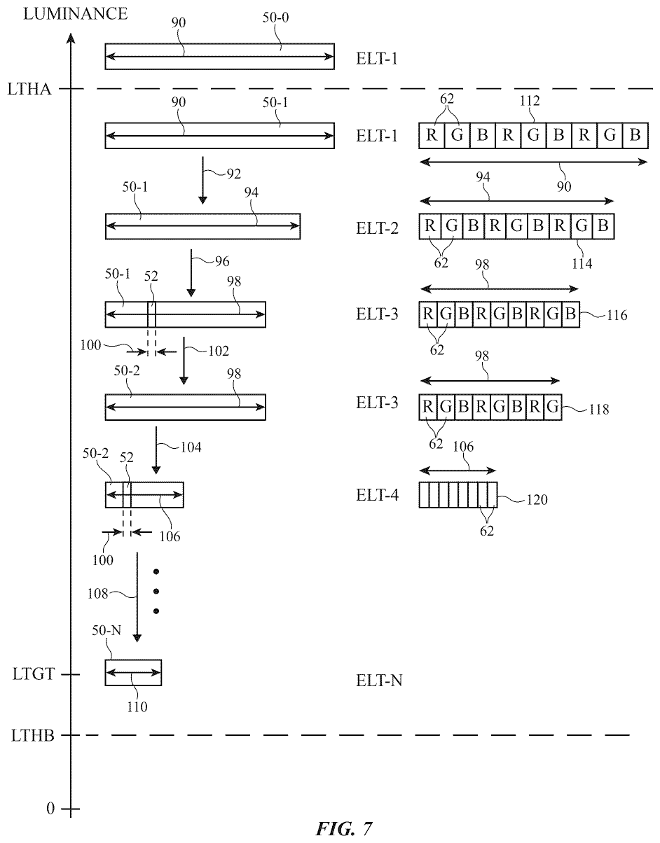

FIG. 7 is a diagram showing how reflective display panel 46 may perform modulation-based dimming (e.g., while processing operation 84 of FIG. 6). The vertical axis of FIG. 7 plots the luminance domain of projector 14A, from a luminance of zero to a luminance exceeding threshold luminance LTHA. Threshold luminance LTHB is greater than zero and less than threshold luminance LTHA. The left column of FIG. 7 illustrates different display modulation sequences 50 that are provided to reflective display panel 46 over time while performing modulation-based dimming. The horizontal dimension of display modulation sequences 50 corresponds to the duration of the display modulation sequence (e.g., the time period during which that display modulation sequence drives reflective display panel 46). The right column of FIG. 7 illustrates one example of color cycles 62 that may be included in the corresponding display modulation sequences 50 shown in the left column of FIG. 7 (e.g., to help illustrate how bit planes are adjusted between modulation sequences while performing modulation-based dimming).

In the example of FIG. 7, hierarchical display dimming is performed to reduce the brightness of projector 14A from a first display brightness level (FIG. 6), corresponding to a luminance exceeding threshold luminance LTHA, down to a second display brightness level (FIG. 6) corresponding to a target luminance LTGT. Analog display dimming (operation 80 of FIG. 6) is first performed to reduce the brightness of projector 14A from the first display brightness level to a brightness level corresponding to threshold luminance LTHA. Modulation-based dimming (operation 84 of FIG. 6) is then performed to further reduce the brightness of projector 14A from the brightness level corresponding to threshold luminance LTHA down to a second display brightness level that corresponds to target luminance LTGT. In the example of FIG. 7, target luminance LTGT exceeds threshold luminance LTHB, so modulation-based dimming is sufficient to reach target luminance LTGT. In examples where target luminance LTGT is less than threshold luminance LTHB, digital dimming (operation 88 of FIG. 6) is performed after modulation-based dimming to further reduce the luminance of projector 14A from threshold luminance LTHB down to the target luminance.

As shown in FIG. 7, projector 14A displays image light 22 using an initial display modulation sequence 50-0 at the end of analog dimming (e.g., projector 14A modulates illumination light 40 using initial display modulation sequence 50-0 while light sources 44 are driven using the minimum stable magnitude and/or duty cycle of drive current ID). Image light 22 has an emission light time (ELT) ELT-1 when produced using initial display modulation sequence 50-0 (e.g., where emission light time is given by integrating over all the bit planes 52 in the display modulation sequence over the duration of the display modulation sequence).

Projector 14A may then begin to perform modulation-based dimming. To begin modulation-based dimming, control circuitry 16 (FIG. 1) may drive reflective display panel 46 (FIG. 3) using image data DAT that includes a first display modulation sequence 50-1. Display modulation sequence 50-1 has a lower bit depth than initial display modulation sequence 50-0. This may, for example, cause display modulation sequence 50-1 to have one or more fewer bit planes 52 than initial display modulation sequence 50-0. At the same time, the control circuitry may time-stretch display modulation sequence 50-1 to have substantially the same sequence duration 90 as initial display modulation sequence 50-0, despite its reduced bit depth. This causes reflective display panel 46 to produce, using display modulation sequence 50-1, image light 22 having approximately the same emission light time ELT-1 as the image light 22 displayed using initial display modulation sequence 50-0. This may serve to minimize noticeable flickering or other artifacts associated with the reduction in bit depth of display modulation sequence 50-1 relative to initial display modulation sequence 50-0.

Block 112 shows one illustrative bit plane configuration for first display modulation sequence 50-1. In the example of FIG. 7, as shown by block 112, first display modulation sequence 50-1 includes nine color fields 62 (e.g., within three color cycles 60 of FIG. 4). Each color field 62 includes a respective set of bit planes 52 (FIG. 4) of the corresponding color (not shown in FIG. 7 for the sake of clarity). The cumulative duration of each of the color fields 62 in display modulation sequence 50-1 is equal to sequence duration 90.

To further dim image light 22, as shown by arrow 92, control circuitry 16 may then drive reflective display panel 46 using image data DAT that includes a time-compressed version of display modulation sequence 50-1. As shown by block 114, the time-compressed version of display modulation sequence 50-1 includes the same color fields 62 (as well as the same underlying bit planes) but lasts for a sequence duration 94 that is less than sequence duration 90. Control circuitry 16 may perform this time compression by reducing the weight (e.g., width 54 of FIG. 4) of one or more (e.g., all) of the bit planes in display modulation sequence 50-1. If desired, the ratio of weights/durations of bit planes or color fields of different colors may be maintained both before and after the time compression or may be adjusted upon time compression. Reflective display panel 46 may modulate illumination light 40 using the time-compressed version of display modulation sequence 50-1, causing the image light to exhibit an emission light time ELT-2 that is less than emission light time ELT-1 (e.g., reducing the luminance of image light 22 relative to before the time-compression of display modulation sequence 50-1).

To further dim image light 22, projector 14A may continue to time-compress display modulation sequence 50-1 until the width 54 (FIG. 4) of one or more of the bit planes 52 in display modulation sequence 50-1 is reduced to a minimum duration 100. Minimum duration 100 is dictated by the least significant bit (LSB) of display modulation sequence 50-1, given its bit depth. For example, as shown by arrow 96, control circuitry 16 may then drive reflective display panel 46 using image data DAT that includes a further time-compressed version of display modulation sequence 50-1. As shown by block 116, the further time-compressed version of display modulation sequence 50-1 includes the same color fields 62 (as well as the same underlying bit planes) but lasts for a sequence duration 98 that is even less than sequence duration 94. Reflective display panel 46 modulates illumination light 40 using the further time-compressed version of display modulation sequence 50-1, causing the image light to exhibit an emission light time ELT-3 that is less than emission light time ELT-2. In this example, the further time-compressed display modulation sequence 50-1 has at least one bit plane 52 that exhibits minimum duration 100. As such, projector 14A will need to adjust the display modulation sequence to perform further dimming.

To continue modulation-based dimming, control circuitry 16 may then drive reflective display panel 46 using image data DAT that includes a second display modulation sequence 50-2 (as shown by arrow 102). Display modulation sequence 50-2 has a lower bit depth than display modulation sequence 50-1. This may, for example, cause display modulation sequence 50-2 to have one or more fewer bit planes 52 than initial display modulation sequence 50-0. Block 118 shows one illustrative bit plane configuration for display modulation sequence 50-2. In the example of FIG. 7, as shown by block 118, display modulation sequence 50-2 includes eight color fields 62 instead of nine as in display modulation sequence 50-1 (e.g., the final blue color field is omitted). This is illustrative and non-limiting. If desired, the reduction in bit depth of display modulation sequence 50-2 relative to display modulation sequence 50-1 may serve to remove any combination of one or more bit planes 52 from one or more of the color fields 62 in the display modulation sequence (e.g., without removing an entire color field), may serve to remove multiple color fields, may serve to remove one or more bit planes from only a single color field/channel, may serve to remove one or more entire color cycles, may serve to remove one or more bit planes from all color fields/channels, etc. If desired, the ratio of weights/durations of bit planes or color fields of different colors may be maintained between display modulation sequences 50-1 and 50-2.

At the same time, the control circuitry may time-stretch display modulation sequence 50-2, to have substantially the same sequence duration 98 as the most recently displayed version of display modulation sequence 50-1 (e.g., the further time compressed version of display modulation sequence 50-1) despite the reduced bit depth of display modulation sequence 50-2. This may cause reflective display panel 46 to produce, using display modulation sequence 50-2, image light 22 having approximately the same emission light time ELT-3 as the image light 22 displayed using the most recent time-compressed version of display modulation sequence 50-1. This may serve to minimize noticeable flickering or other artifacts associated with the reduction in bit depth of display modulation sequence 50-2 relative to display modulation sequence 50-1.

To further dim image light 22, control circuitry 16 may then continue time-compress display modulation sequence 50-2 until a bit plane 52 in display modulation sequence 50-2 reaches minimum duration 100. For example, as shown by arrow 104, control circuitry 16 may then drive reflective display panel 46 using image data DAT that includes a time-compressed version of display modulation sequence 50-2. As shown by block 120, the time-compressed version of display modulation sequence 50-2 includes the same color fields 62 (as well as the same underlying bit planes) but lasts for a sequence duration 106 that is even less than sequence duration 98. Reflective display panel 46 modulates illumination light 40 using the time-compressed version of display modulation sequence 50-2, causing the image light to exhibit an emission light time ELT-4 that is less than emission light time ELT-3. In this example, the time-compressed display modulation sequence 50-2 has at least one bit plane 52 that exhibits minimum duration 100. As such, projector 14A will need to further reduce the bit depth of the display modulation sequence to perform further dimming.

Reducing the bit depth of display modulation sequence 50 may create the additional headroom needed to time-stretch each new display modulation sequence to match the duration of the most time-compressed version of the previous display modulation sequence, which serves to minimize flicker. This process of reducing the bit depth of the display modulation sequence, time-compressing the display modulation sequence until the LSB pulse width is reached, and then further reducing the bit depth of the display modulation sequence may continue until image light 22 reaches target luminance LTGT or until image light 22 reaches threshold luminance LTHB. Projector 14A may switch to digital dimming if/when image light 22 reaches threshold luminance LTHB. In the example of FIG. 7, projector 14A reaches target luminance LTGT (e.g., corresponding to the second display brightness level of FIG. 5) when a display modulation sequence 50-N having sequence duration 110 is used to drive reflective display panel 46. The image light 22 produced by reflective display panel 46 using display modulation sequence 50-N may reach the eye box with minimal or no visible postcard artifacts.

This process may be reversed when performing hierarchical display brightening (e.g., at operation 76 of FIG. 5). During modulation-based brightening, projector 14A may time-stretch and increase the bit depth of the display modulation sequences 50 provided to reflective display panel 46 over time. If desired, projector 14A may perform time compression upon each increase of bit depth to match the ELT of an increased bit depth display modulation sequence with the most recently used display modulation sequence of lower bit depth. Once threshold luminance LTHA is reached, projector 14A may perform analog display brightening (e.g., by increasing the magnitude and/or duty cycle of the drive current ID provided to light sources 44).

The example of FIG. 7 is illustrative and non-limiting. In general, any desired number of display modulation sequences 50 of different bit depths may be used while performing modulation-based dimming/brightening. If desired, the number of color cycles 60 (FIG. 4) in each display modulation sequence 50 may be adjusted between different display modulation sequences 50 (e.g., between display modulation sequences 50-0 and 50-1, between display modulation sequences 50-1 and 50-2, etc.) to allow for further time-stretching of the LSB while preserving the same duty cycle at the transition. As one example, initial display modulation sequence 50-0 may include two color cycles (e.g., having six color fields 62: RGBRGB) whereas display modulation sequence 50-1 includes only a single color cycle (e.g., having three color fields 62: RGB), which may provide additional headroom to further stretch the LSB of the sequence while preserving duty cycle. In general, each display modulation sequence 50 may include any desired number of color cycles or fewer than a single color cycle. If desired, projector 14A may allow a small luminance drop between different display modulation sequences 50 (e.g., by tuning the next display modulation sequence to map a desired brightness ramp profile or brightness ramp step). If desired, analog dimming (e.g., adjustment to drive current ID) and/or digital dimming (e.g., digital pixel value adjustment) may be performed concurrent with modulation-based dimming to reach a desired target luminance (e.g., two or more of operations 80-88 of FIG. 6 may be performed concurrently).

If desired, each display modulation sequence 50 used during hierarchical dimming or brightening may be calibrated at the illumination source, projector, and full system level (e.g., prior to providing system 10 to an end user or in the field while system 10 is operated by an end user) to enable a seamless transition and to account for variations such as non-idealities in the illumination or driving electronics, as well as part-to-part variations. Such calibration may, for example, involve measuring the optical response of the display when driven under a given modulation sequence and updating the corresponding timing or display modulation settings. In general, the display modulation sequences 50 used during modulation-based dimming/brightening may be optimized to minimize perceptual artifacts while accounting for content brightness level and ambient light levels or environmental conditions. For example, dithering artifacts may be less visible when the brightness of the projector is reduced, allowing a higher tolerance for increasing the LSB temporal width or reducing the effective bit depth of the transition sequence. Stretch factors for each display modulation sequence 50 may be calibrated to match the luminance at transition relative to the previous display modulation sequence. Sequence design and flicker metrics may be used to optimize the display modulation sequences to account for waveform differences. Native bit depth mismatch may be mitigated by adding additional intermediate display modulation sequences.

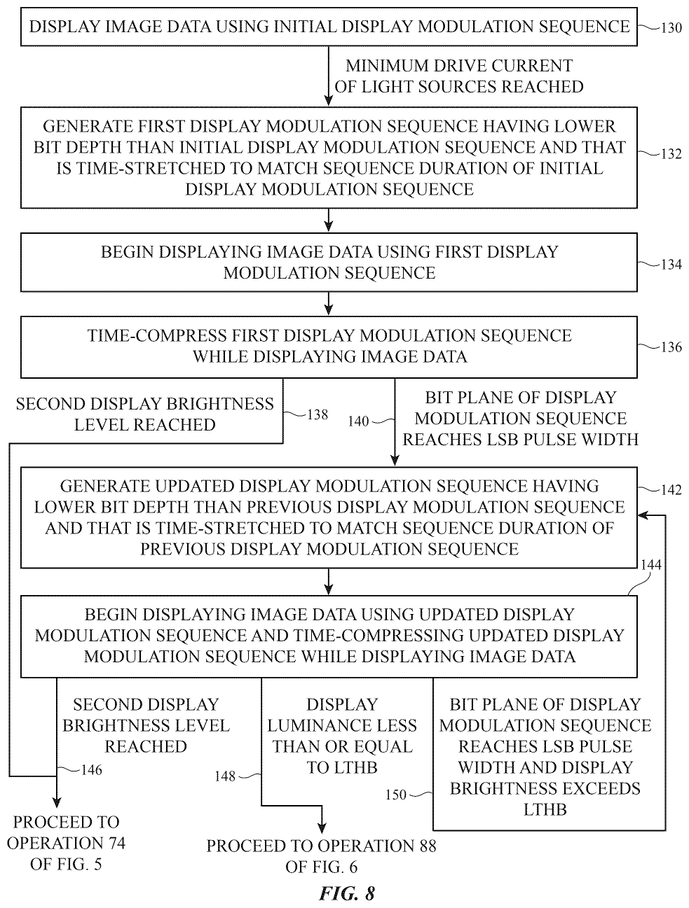

FIG. 8 is a flow chart of illustrative operations involved in performing the modulation-based dimming shown in FIG. 7. The operations of FIG. 8 may, for example, be performed while processing operations 80 and 84 of FIG. 6.

At operation 130, projector 14A may generate image light 22 using one or more display modulation sequences 50 while reducing the luminance of illumination light 40 (e.g., while performing analog dimming at operation 80 of FIG. 6). The final display modulation sequence used while performing analog dimming may be display modulation sequence 50-0 of FIG. 8, for example. Processing proceeds to operation 132 when the minimum magnitude and/or duty cycle of the drive current ID supplied to light sources 44 is reached.

At operation 132, control circuitry 16 (FIG. 1) may generate a first display modulation sequence with a lower bit depth than initial display modulation sequence 50-0 (e.g., display modulation sequence 50-1 of FIG. 7). Control circuitry 16 may also time-stretch the first display modulation sequence to exhibit a sequence duration 90 that matches the sequence duration of initial display modulation sequence 50-0 (e.g., to mitigate flicker between use of display modulation sequences 50-0 and 50-1).

At operation 134, projector 14A may generate image light 22 by modulating illumination light 40 using the first display modulation sequence.

At operation 136, projector 14A may continue to generate image light 22 by modulating illumination light 40 using one or more time-compressed versions of the first display modulation sequence (e.g., may generate image light 22 at a first time using the time-compressed display modulation sequence 50-1 shown by block 114 of FIG. 7, may generate image light 22 at a second time using the further time-compressed display modulation sequence 50-1 shown by block 116 of FIG. 7, etc.). If/when projector 14A reaches target luminance LTGT (or the second display brightness level of FIG. 5) before the time-compressed versions of display modulation sequence 50-1 have a bit plane 52 with a width 54 that is less than or equal to minimum duration 100, processing may proceed to operation 74 of FIG. 5 via path 138. On the other hand, if/when time-compressed display modulation sequence 50-1 has a bit plane 52 with a width 54 that is less than or equal to minimum duration 100, processing may proceed to operation 142 via path 140.

At operation 142, control circuitry 16 may generate an updated display modulation sequence (e.g., display modulation sequence 50-2 of FIG. 7) having a lower bit depth than the previous display modulation sequence used to generate image light 22. Control circuitry 16 may also time-stretch the updated display modulation sequence to exhibit a sequence duration that matches the sequence duration of the most time-compressed version of the previous display modulation sequence used to produce image light 22 (e.g., to mitigate flicker between use of display modulation sequence 50-2 and the most time-compressed version of display modulation sequence 50-1).

At operation 144, projector 14A may begin to generate image light 22 by modulating illumination light 40 using the updated display modulation sequence (e.g., display modulation sequence 50-2 of FIG. 7). Projector 14A may continue to generate image light 22 by time-compressing the updated display modulation sequence until the updated display modulation sequence has a bit plane 52 with a width 54 that is less than or equal to minimum duration 100. If/when the time-compressed versions of the updated display modulation sequence have a bit plane with a width 54 that is less than or equal to minimum duration 100 (e.g., a bit plane that reaches the LSB pulse width) and the luminance image light 22 exceeds threshold luminance LTHB, processing may loop back to operation 142 via path 150 and a new updated display modulation sequence having an even lower bit depth may be used. If/when projector 14A reaches target luminance LTGT (or the second display brightness level of FIG. 5) before the time-compressed versions of the updated display modulation sequence have a bit plane 52 with a width 54 that is less than or equal to minimum duration 100, processing may proceed to operation 74 of FIG. 5 via path 146 (e.g., when display modulation sequence 50-N of FIG. 7 is used, causing the projector to produce image light 22 at target luminance LTGT). On the other hand, if/when projector 14A produces image light 22 having a luminance less than or equal to threshold LTHB, modulation-based dimming may be insufficient to reach the second display brightness level and processing may proceed to digital dimming (e.g., to operation 88 of FIG. 6 via path 148). The operations of FIG. 8 may be time-reversed to perform modulation-based brightening (e.g., while processing operation 76 of FIG. 5).

The methods and operations described above in connection with FIGS. 1-8 may be performed by the components of system 10 using software, firmware, and/or hardware (e.g., dedicated circuitry or hardware). Software code for performing these operations may be stored on non-transitory computer readable storage media (e.g., tangible computer readable storage media) stored on one or more of the components of system 10 (e.g., the storage circuitry within control circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of system 10 (e.g., one or more processors in control circuitry 16). The processing circuitry may include microprocessors, application processors, digital signal processors, central processing units (CPUs), application-specific integrated circuits with processing circuitry, or other processing circuitry.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” The term “when” also implies at least some concurrency (e.g., event A occurring “when” event B occurs means that at least some of event A is concurrent with at least some of event B).

System 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
one or more light sources configured to generate illumination light based on a drive signal;
a reflective display panel configured to receive image data and configured to generate image light by reflecting the illumination light based on the image data;
a waveguide configured to direct the image light towards an eye box; and
one or more processors configured to
adjust the image light between a first brightness and a second brightness using the drive signal, the second brightness being lower than the first brightness, and
adjust the image light between the second brightness and a third brightness by adjusting bit planes of a display modulation sequence in the image data, the third brightness being lower than the second brightness.

2. The electronic device of claim 1, the one or more processors being further configured to:
adjust the image light between the third brightness and a fourth brightness by digitally adjusting pixel values of the image data, the fourth brightness being lower than the third brightness.

3. The electronic device of claim 1, the one or more processors begin further configured to:
supply the drive signal to the one or more light sources at a first magnitude when the image light is at the first brightness,
supply the drive signal to the one or more light sources at a second magnitude lower than the first magnitude when the image light is at the second brightness, and
supply the drive signal to the one or more light sources at the second magnitude when the image light is between the second brightness and the third brightness.

4. The electronic device of claim 1, the one or more processors begin further configured to:
supply the drive signal to the one or more light sources using a first pulse width modulation when the image light is at the first brightness,
supply the drive signal to the one or more light sources using a second pulse width modulation different from the first pulse width modulation when the image light is at the second brightness, and
supply the drive signal to the one or more light sources using the second pulse width modulation when the image light is between the second brightness and the third brightness.

5. The electronic device of claim 1, the one or more processors being further configured to adjust the image light between the second brightness and the third brightness by adjusting a bit depth of the display modulation sequence.

6. The electronic device of claim 5, wherein the bit depth of the display modulation sequence is higher when the image light is at a higher brightness between the second brightness and the third brightness than when the image light is at a lower brightness between the second brightness and the third brightness.

7. The electronic device of claim 6, the one or more processors being further configured to adjust the image light between the second brightness and the third brightness by adjusting a duration of the display modulation sequence.

8. The electronic device of claim 7, wherein the duration of the display modulation sequence is higher when the image light is at the higher brightness between the second brightness and the third brightness than when the image light is at the lower brightness between the second brightness and the third brightness.

9. The electronic device of claim 1, the one or more processors being further configured to adjust the image light between the second brightness and the third brightness by adjusting a duration of the display modulation sequence.

10. The electronic device of claim 9, wherein the duration of the display modulation sequence is higher when the image light is at a higher brightness between the second brightness and the third brightness than when the image light is at a lower brightness between the second brightness and the third brightness.

11. An electronic device comprising:
one or more light sources configured to generate illumination light;
a reflective display panel configured to receive image data and configured to generate image light by reflecting the illumination light based on the image data, wherein the image data implements a display modulation sequence;
a waveguide configured to direct the image light towards an eye box; and
one or more processors configured to dim the image light by at least reducing a bit depth of the display modulation sequence.

12. The electronic device of claim 11, the one or more processors being further configured to dim the light by time-compressing the display modulation sequence.

13. The electronic device of claim 11, the one or more processors being further configured to:
drive, at a first time, the reflective display panel using a first display modulation sequence having a first bit depth; and
drive, at a second time after the first time, the reflective display panel using a second display modulation sequence having a second bit depth less than the first bit depth.

14. The electronic device of claim 13, the one or more processors being further configured to:
drive, at a third time after the second time, the reflective display panel using a third display modulation sequence having a third bit depth less than the second bit depth, wherein the image light has a first brightness while the reflective display panel is driven using the first display modulation sequence and has a second brightness less than the first brightness while the reflective display panel is driven using the third display modulation sequence.

15. The electronic device of claim 14, wherein the first display modulation sequence has a first duration, the second display modulation sequence has the first duration, and the third modulation sequence has a second duration less than the first duration.

16. The electronic device of claim 13, the one or more processors being further configured to:
drive, at a third time after the second time, the reflective display panel using a time-compressed version of the second display modulation sequence.

17. A method of operating an electronic device, the method comprising:
generating, using one or more light sources, illumination light;
generating, using a reflective display panel, image light based on the illumination light;
directing, using a waveguide, the image light towards an eye box; and
dimming, using one or more processors, the image light, wherein dimming the image light comprises
driving, at a first time, the reflective display panel using a first sequence of bit planes for a first duration, and
driving, at a second time after the first time, the reflective display panel using the first sequence of bit planes for a second duration less than the first duration.

18. The method of claim 17, wherein dimming the image light further comprises:
driving, at a third time after the second time, the reflective display panel using a second sequence of bit planes, the second sequence having lower bit depth than the first sequence.

19. The method of claim 18, wherein driving the reflective display panel using the second sequence of bit planes comprises driving the reflective display panel using the second sequence of bit planes for the second duration.

20. The method of claim 19, dimming the image light further comprises:
driving, at a fourth time after the third time, the reflective display panel using a third sequence of bit planes, the third sequence having lower bit depth than the second sequence.
